(19) United States
(12) Patent Application Publication
(10) Pub. No.: US 2023/0068433 A1
(43) Pub. Date: Mar. 2, 2023

(54) DYNAMIC ESG VISUALIZATION

(71) Applicant: Royal Bank of Canada, Toronto (CA)

(72) Inventors: Lindsay Puls, Burlington (CA); Michael Chen, London (CA); Ori Wiegner, Richmond Hill (CA); Calla Lu, Scarborough (CA)

(21) Appl. No.: 17/891,548

(22) Filed: Aug. 19, 2022

Related U.S. Application Data
(60) Provisional application No. 63/237,699, filed on Aug. 27, 2021.

(51) Int. Cl. G06Q 10/06

(52) U.S. Cl. CPC G06Q 10/06393

(57) ABSTRACT

A method is provided for dynamically visualizing an impact field based on weighted ESG. A portfolio is received, which includes a plurality of assets according to a first configuration, each asset having an associated quantum variable. A raw ESG score is retrieved for each of the assets. A weighted ESG score is determined for each asset by multiplying the raw ESG score by the quantum variable. A first composite ESG score is formed by summing the weighted ESG scores for the assets in the first configuration of the portfolio. This is then visually represented by rendering and displaying an impact field having a gradient variable reflective of the first composite ESG score. A recommendation is made for at least one asset in the first configuration. The configuration is changed, another composite ESG score is determined, and the impact field is updated accordingly.

### CROSS-REFERENCE TO RELATED APPLICATION

The present application claims priority to U.S. Provisional Application No. 63/237,699, filed on Aug. 27, 2021, and entitled “Dynamic ESG Visualization”, the entirety of which is hereby incorporated by reference.

### TECHNICAL FIELD

The present disclosure is directed at methods, systems, and techniques for dynamically displaying ESG information responsive to portfolio changes.

### BACKGROUND

“Environmental, social and governance” factors are increasingly on the minds of many investors, even if they have never heard of the acronym ESG. Investors may be interested in making their investment portfolios “greener” or more “socially aware”. However, few tools have been available to advisors to respond to such concerns or to provide guidance directed to the particular issues of interest to their clients without swamping such clients with data overload, leading to paralysis. It would be desirable to help advisors apply responsible investing principles and metrics to portfolios to assist their clients.

### SUMMARY

According to a first aspect, there is provided a method of dynamically visualizing an impact field based on weighted ESG. A portfolio is received, which includes a plurality of assets according to a first configuration, each asset having an associated quantum variable. A raw ESG score is retrieved for each of the assets. A weighted ESG score is determined for each asset by multiplying the raw ESG score by the quantum variable. A first composite ESG score is formed by summing the weighted ESG scores for the assets in the first configuration of the portfolio. This is then visually represented by rendering and displaying an impact field having a gradient variable reflective of the first composite ESG score. A recommendation is made for at least one asset in the first configuration. An instruction is received to reduce or increase the quantum variable of at least one asset, or to drop or add an asset, to form a second configuration of the portfolio. A raw ESG score is then retrieved for any new asset (post-instruction). A weighted ESG score is determined for any new or modified asset by multiplying the raw ESG score by the quantum variable of the new or modified asset. A second composite ESG score is formed by summing the weighted ESG scores for the assets in the second configuration of the portfolio. This second configuration of the portfolio is then visually represented by modifying the appearance of the impact field through adjustment of the gradient so as to reflect the second composite ESG score.

The quantum variable may be expressed in: shares, value, relative ranking within the portfolio by shares, or relative ranking within the portfolio by value.

In some embodiments, at least one of the retrieving steps includes retrieving ESG scores from multiple sources. In this case, the method may also include selecting one score from the multiple sources based on a predetermined criteria. Alternatively or in addition, the scores may be combined. A conversion factor may be applied prior to combining the scores. The scores may be aggregated to combined, or added, or they may be averaged (with or without weighting).

In some embodiments, the raw ESG scores include sets of sub-scores based on multiple issues.

An issue preference may be received from the user. In this case, the method may further include filtering the raw ESG scores to reflect only the sub-scores associated with the issue preference received from the user. Further, the impact field may apply a graphical template reflective of the issue preference.

The gradient variable may be selected from the group consisting of: intensity of a colour, position on a spectrum between two or more colours, number of a positive icon or graphic, number of a negative icon or graphic, and relative balance between positive icons or graphics and negative icons or graphics. For example, the gradient variable may include the visible health of an organism.

Various output options are contemplated. In some embodiments, the impact field may be output to a different device than the recommendation. The scores may be output to a different device than the impact field. (In other embodiments, such as self-service embodiments, all information and impact field may be displayed on the same device or to the same user.) Preferably, the impact field is displayed to a holder of the portfolio. The scores may be displayed to an advisor to the holder of the portfolio.

The portfolio may be a fantasy portfolio, for example, and the impact field may be part of a financial simulator. In other embodiments, the portfolio may be an actual portfolio retrieved from a holder’s account. In some cases, the method further includes executing a transaction with respect to an asset in the holder’s account.

Preferably, the impact field is interactive. Interacting with the field may, for example, generate messages pertaining to the assets, the portfolio, the ESG scores, or the recommendation.

A history of instructions and configurations may be stored, and a persona of the holder (client) may be formed based on the history of instructions and configurations. In this case, the method may further include outputting a message or a modification of the impact field based on the persona. The message may be a recommendation based on past likes or patterns of instructions and configurations.

In some embodiments, the method may further include segmenting the portfolio by sector, region, currency, asset type or asset class.

The recommendation may be made by applying a machine learning model. For example, an unsupervised machine learning model may be applied. In some embodiments, the machine learning model may be a nearest neighbors model. The machine learning model may also be a k-means clustering model. The machine learning model may provide a recommendation in the form of a fund representing multiple companies and/or in the form of one or more of the companies themselves.

According to another aspect, there is provided a system for dynamically visualizing an impact field based on weighted environmental, social, and governance (ESG) metrics, comprising a terminal communicative with at least one server, the terminal and the at least one server collective configured to perform the foregoing method.

According to another aspect, there is provided a non-transitory computer readable medium having stored thereon computer program code that is executable by a processor and that, when executed by the processor, causes the processor to perform the foregoing method.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a network diagram illustrating one architecture used to implement a system for performing dynamic ESG visualization, according to an example embodiment.

FIG. 2 is a block diagram of a server comprising part of the architecture of FIG. 1.

FIG. 3 is a more specific architecture diagram illustrating an advisor view and possible data sources for a data center comprising part of the architecture of FIG. 1.

FIG. 4 is a screen shot of an advisor terminal view (dashboard) with a first portfolio configuration, according to an example embodiment.

FIG. 5 is an example screen shot of a user device view of an impact field according to the first portfolio configuration.

FIG. 6 is a screen shot of an advisor terminal view (dashboard) with a second portfolio configuration, according to an example embodiment.

FIG. 7 is an example screen shot of a user device view of an impact field according to the second portfolio configuration.

FIG. 8 is a flow diagram based on the method used in connection with FIGS. 4-7, according to an example embodiment.

FIG. 9 is a flow diagram of overall process flow (alternative self-serve model), according to an example embodiment.

FIG. 10 is an example sequence diagram based on FIG. 8.

### DETAILED DESCRIPTION

Currently available environmental, social and governance (ESG) scoring systems provide qualitative and quantitative evaluations of individual companies or assets based on risks and perceptions of management of those risks. However, these systems (e.g. MSCI™ ESG ratings or Morningstar Sustainalytics™) have heterogeneous approaches and are not easily accessible to or straightforward for everyday investors to analyze. Further, as such scores or ratings are based on individual companies or assets, it has not been possible for advisors or their clients to evaluate the impact on multiple securities or an entire portfolio. It would be desirable to compile and illustrate such scores to allow investors to make choices and see the impact of tradeoffs across multiple securities or an entire portfolio.

Further, for financial institutions hoping to provide their clients with ESG concerns access to responsible investing choices, it would be desirable to offer visualization tools and targeted recommendations to provide simplified messaging to clients and avoid data overload, therefore enabling actionable decisions.

In at least some embodiments herein, methods, systems and techniques are provided for dynamically visualizing an impact field based on weighted ESG metrics. An interactive, visualization dashboard is provided for wealth management investment advisors to conduct portfolio customization that incorporates responsible investing. Responsible investing includes a company’s ESG metrics. ESG metrics are scores that relate to independently-evaluated risks in environmental, social and governance issues. The E, S and G components of these scores are considered “pillars”, while sub-scores relate to specific “issues” such as board diversity, human rights record, carbon emissions, or water usage.

Investors may use this information alone, or together with traditional metrics such as financial performance over time. Investors may be absolutist about ESG information or may tolerate certain tradeoffs.

In at least some embodiments, the dashboard product (or suite) allows for:
1. displaying ESG data in a simple way;
2. providing easy educational components for ESG; and
3. facilitating portfolio customization, construction and editing.

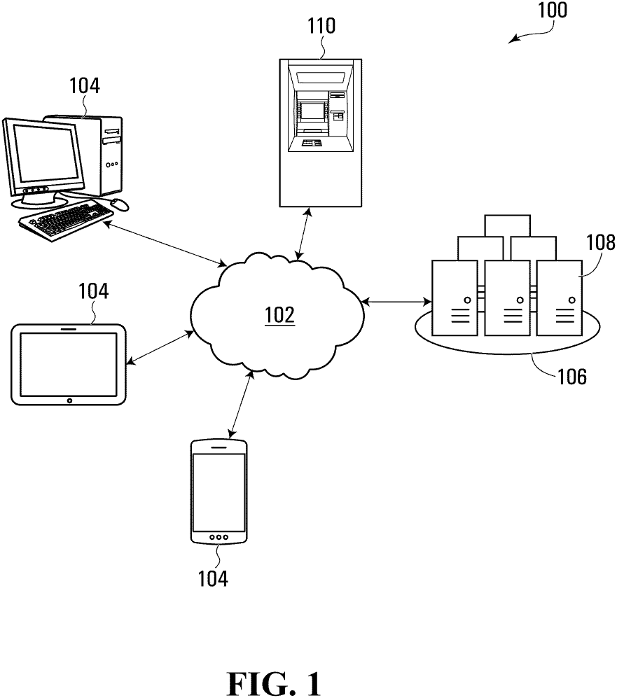

The tool may be part of a network environment, which may take various configurations. Referring now to FIG. 1, there is shown a computer network 100 that comprises an example embodiment of a system for dynamically visualizing an impact field based on weighted ESG metrics. More particularly, the computer network 100 comprises a wide area network 102 such as the Internet to which various user devices 104, an advisor terminal 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as managing investment portfolios. Furthermore, individuals may meet remotely or in person with an advisor accessing the advisor terminal 110 to view and manage investment accounts controlled by the data center 106.

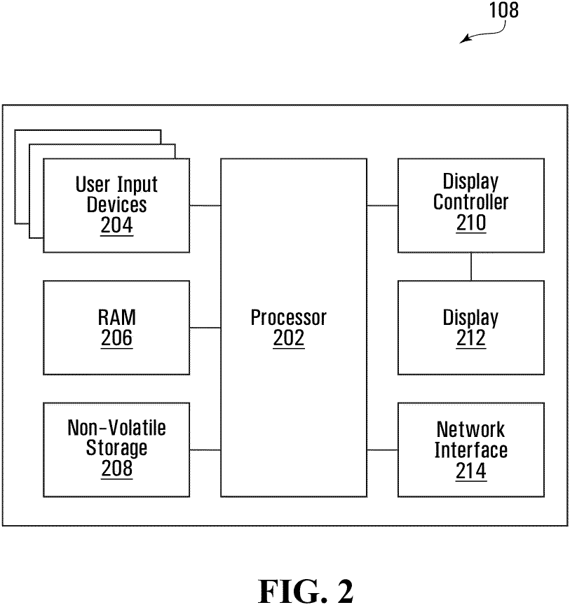

Referring now to FIG. 2, there is depicted an example embodiment of one of the servers 108 that comprises the data center 106. The server comprises a processor 202 that controls the server’s 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for dynamically visualizing an impact field based on weighted ESG metrics such as is described in more detail below. Additionally or alternatively, the servers 108 may collectively perform that method using distributed computing. While the system depicted in FIG. 2 is described specifically in respect of one of the servers 108, analogous versions of the system may also be used for the user devices 104 and for the advisor terminal 110.

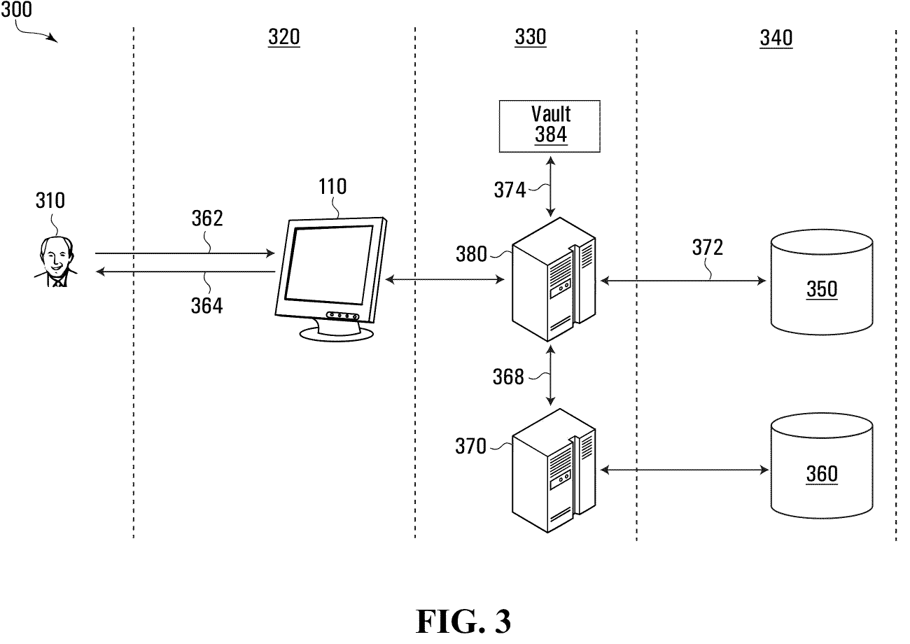

FIG. 3 shows a more specific architecture diagram 300 illustrating how to implement an advisor view and possible data sources for the data center 106. The advisor 310 through an advisor application (dashboard) on an advisor terminal 110 (e.g. on a browser application 320) requests to import client portfolio data (arrow 362). This request is directed to a backend application 330 (arrow 366) running on an application server 380, which in turn queries a database(s) 340 (arrow 372) on a database server 350. The application server 380 may store secrets, such as passwords and digital signatures, in a vault 384 (arrow 374). Portfolio data is reported (e.g. in CSV format) to the advisor 310 via the advisor terminal 110 together with ESG (environmental, social, governance) score data (arrows 372, 366, and 364) either from the same data sources or from external data sources 360. As the advisor 310 interacts with the ESG data returned on the portfolio assets, comparable assets may also be retrieved (arrow 368) which have been pre-selected as comparables based on machine learning clustering (processed, for example, on a separate machine learning model server 370), and/or an algorithmic process. Where machine learning is used, recommendations may be accompanied by a survey question to ask whether the recommendation is helpful. Using this feedback, machine learning models that may benefit from retraining may be flagged. In FIG. 3, the browser application may be implemented using React.js; the machine learning server 370 may run Python Jupyter Notebook™; the application server 320 may run the Flask™ web framework; and the browser application 320 may request to import client portfolio data via HTTP GET or POST commands sent to the application server 320.

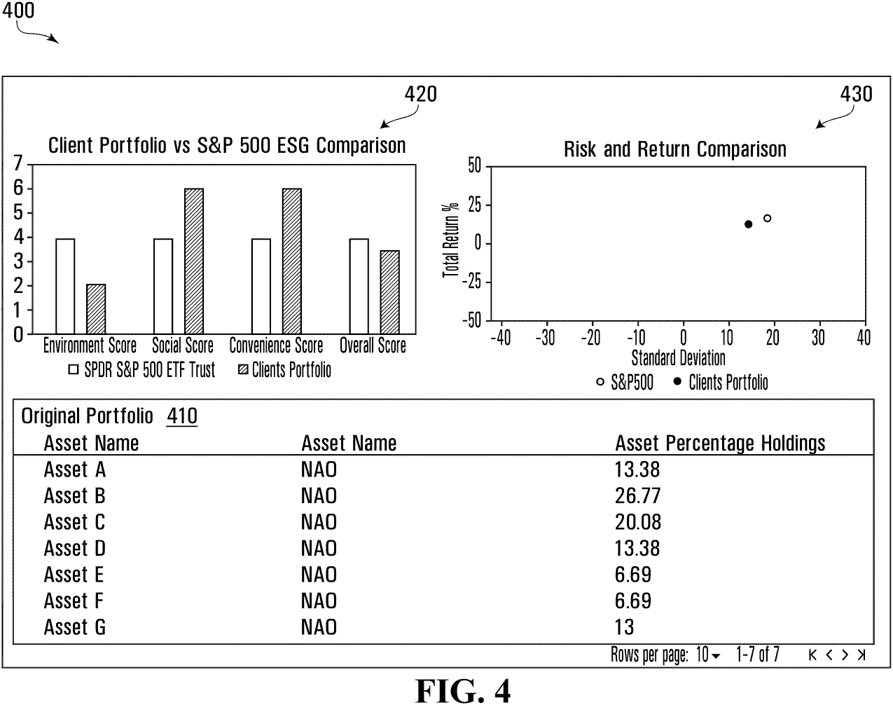

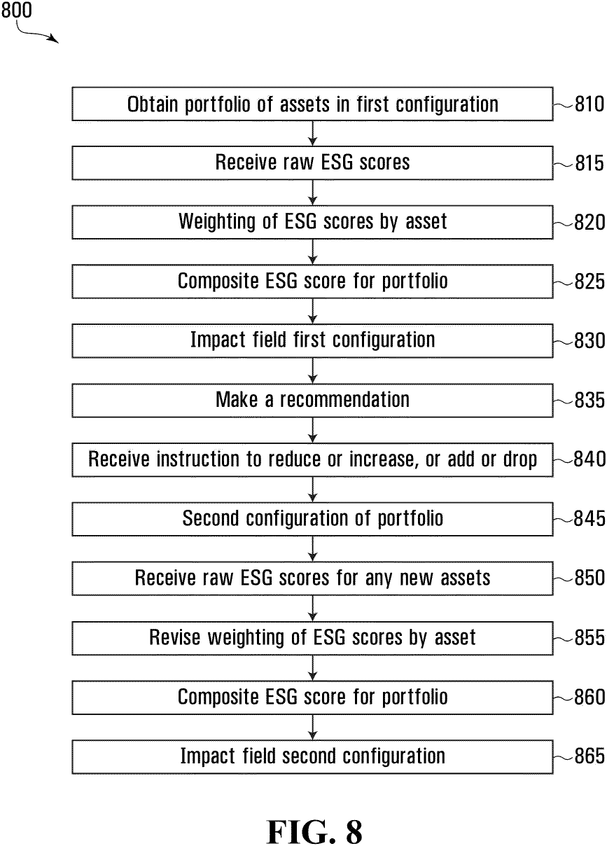

FIG. 8 illustrates a process flow 800 using advisor and client views. Sample corresponding advisor and client views are shown in FIGS. 4-7. To begin, a portfolio of assets is obtained in a first configuration (block 810); for example, the portfolio may be uploaded by a user or created by the user on the advisor terminal 110. Raw ESG scores are received (block 815) and weighted by asset (block 820), and a derived composite ESG score is determined for the entire portfolio (block 825). An impact field is generated based on the first configuration (original portfolio) (block 830). A recommendation is made (block 835). An instruction is received to reduce or increase or add or drop an asset (block 840). This results in a second configuration of the portfolio (modified portfolio) (block 845). ESG scores are retrieved for any new assets (block 850). The weighting is revised 855 and a composite ESG score for the portfolio is determined (block 860). A revised impact field is generated based on the second configuration (modified portfolio) (block 865). In FIG. 8, making a recommendation at block 835 may be performed by the machine learning server 370 when the recommendation is based on applying machine learning; determining ESG scores, including composite and weighted scores, at blocks 820, 825, 855, and 860 is performed by the backend application 330; determining portfolio configurations based on scores, such as at block 845, is also performed by the backend application 330; and interfacing with a user of the system and rendering the impact fields at blocks 810, 815, 830, 840, 850, and 865 is performed by the browser application. However, functionality may be performed by different components of the system in different embodiments.

FIG. 4 illustrates a sample advisor view for the first configuration using a sample portfolio. The portfolio may be populated from client account information previously stored. The stored client account information may, for example, be stored in CSV format on the advisor terminal 110.

FIG. 4 is a screen shot 400 of an advisor terminal view with a first portfolio configuration 410. Using ESG raw data, weighted ESG scores (e.g., a weighted average based on asset percentage holdings) and/or composite score(s) for the portfolio are derived. The ESG data may be retrieved for example from subscription ESG score data. The ESG data can be shown in comparison to an ESG benchmark on one or multiple pillars (e.g. S&P 500 ESG) 420. The risk and return can likewise be shown compared with a benchmark 430.

When multiple sources are used for ESG data, the metrics for companies might not match up with the metrics of the funds as they get more specific. Specific metrics may need to be combined in a way that takes account of their heterogeneity - e.g. carbon emissions vs. carbon intensity.

For example, certain scoring systems show a company rating along a scale:

| | | | | | | | |
|---|---|---|---|---|---|---|---|
| Grade | CCC | B | BB | BBB | A | AA | AAA |
| Category | “Laggard” | | “Average” | | | “Leader” | |

Other scoring systems show ESG in terms of a risk rating:

| Negligible | Low | Medium | High | Severe |
|---|---|---|---|---|
| 0-10 | 10-20 | 20-30 | 30-40 | 40+ |

In order to handle such heterogeneity, various approaches are possible. In certain embodiments, the source may be manually selectable (by the advisor or an administrator) or the source may be automatically selected based on a detected level of interest in a particular ESG measurement or issue particular to one source or another. The ESG data may also be aggregated or averaged from multiple sources (with or without rescaling, indexing or conversion techniques) and pre-processed in various ways (e.g. filtered to focus on ESG issues/pillars relevant to the client).

In this case, the advisor is presented with a portfolio of assets having the following holdings:
Asset A
Asset B
Asset C
Asset D
Asset E
Asset F
Asset G

The ESG scores of the assets are weighted by a quantum variable. In the case of the first portfolio configuration 410, the ESG scores are weighted by the proportion of the asset relative to the portfolio as a whole (“Asset Percent Holdings”). Various weighting methods (using other quantum variables) are possible and contemplated, such as weighting by shares, by value, by relative ranking within the portfolio by shares, or relative ranking within the portfolio by value. Handling for different regions or currencies may also be provided.

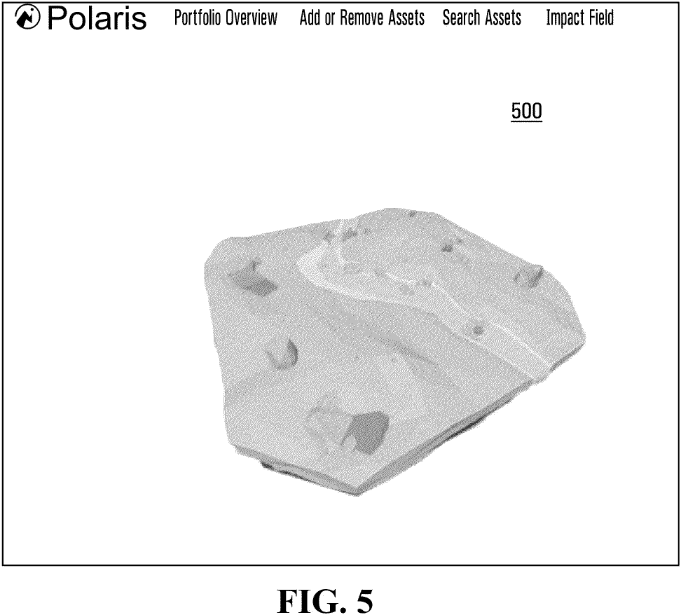

To give the client a simplified view of how their portfolio looks from an ESG standpoint, the impact field may be provided as shown in FIG. 5. The impact field is an impact visualization tool, which in this case may provide a visualization with respect to the ESG impact of an investment portfolio. In one embodiment, this is a rendered 3D impact field 500, which may or may not be interactive and may or may not include animation. (The illustration in this case is based on a starting 3D model from Sketchfab by creator Kagelok used under CC Attribution.)

To obtain the impact field that is displayed to the client, the composite ESG score is used to select or generate a graphical rendering. The graphical rendering in at least some embodiments has a gradient variable (e.g. intensity of a colour [e.g. dull green vs. bright green, or by PANTONE™ between shades], position on a spectrum between two or more colours [e.g. green vs. brown], number of a positive icon or graphic [e.g. bunny rabbits, trees, rivers, wildlife, etc.], number of a negative icon or graphic [e.g. smokestacks], and relative balance between positive icons or graphics and negative icons or graphics). The gradient variable may also be keyed to another analogous figure such as a health of a game character, and the character may be interactive. In some embodiments, the impact field may be selected based on a detected location of the client (e.g. detected through sensors in client’s device determined through localized application or by known location of account or predominant location of assets) or a detected time of year (e.g. showing local landmarks in a scene, or summer or winter themes). In some embodiments, the graphical elements are selected from a bank of templates. Which template is selected may depend on known or detected issue preferences or concerns of a client.

In the example of FIG. 5, the composite ESG score is keyed to a modified impact field 500 showing a relatively barren landscape. The impact field 500 thus provides a visual indicator of the “health” of the portfolio in ESG terms. In other embodiments (not shown), the graphic may be selected to reflect ESG values on other metrics, such as board diversity (being illustrated with a more- or less-diverse set of avatars) or a sun graphic shining more or less brightly to illustrate other metrics.

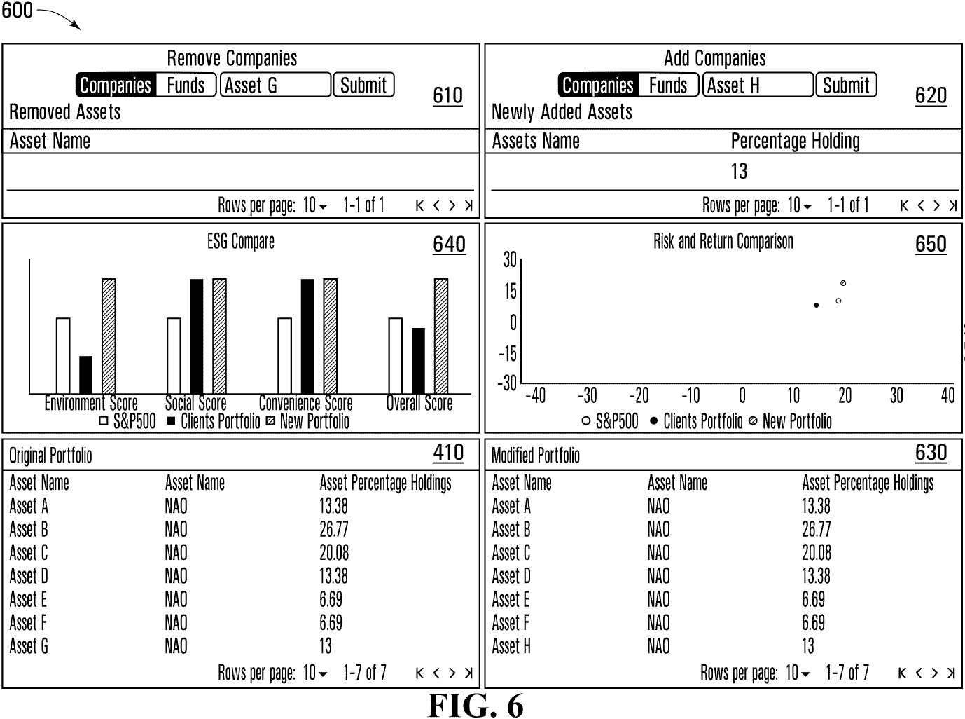

Recommendations may be made in the advisor view or the client view or both. The advisor or the client may also be provided with various options to reduce or increase the holdings of any one asset, or to add or drop assets. Addition of assets may use a search capability (e.g. by common names or trading symbols) or by sector or by selecting an asset provided in a recommendation. Tickers or ISIN values may be used for cross-referencing. Recommendations may be provided in a list, which may be ranked according to best fit for the client or best lift from an ESG or performance perspective (or combined ESG and performance lift). Once all changes are made (these may be actual transactions or simulated or “fantasy” transactions), a second configuration of the portfolio may be displayed, as depicted in FIG. 6.

As shown in FIG. 6, through the advisor terminal 110, assets can be removed by specifying them using a removal form 610 and added by specifying them using an addition form 620 (e.g. here, Asset G was removed and Asset H was added), and the original first portfolio configuration 410 and modified configuration 630 can be shown with comparisons. Here, the comparison 640 is provided in ESG terms to both benchmark and original portfolio. A risk & return comparison 650 is provided comparing a benchmark (the S&P 500 in FIG. 6) with the portfolio in its original and modified configurations.

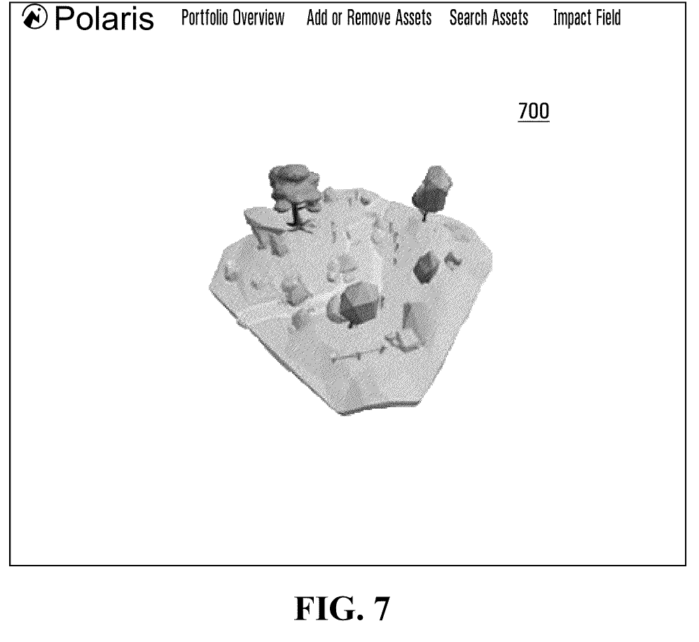

The ESG scores of any added assets are received and weighted, and the revised composite ESG score for the portfolio is tabulated. This in turn allows the revised impact field to be displayed to the client, advisor or both. As can be seen from FIG. 7, the impact field 500 that was shown in FIG. 5 has been automatically modified, resulting in a modified impact field 700. In response to the change of the composite ESG score, the barren field is now more lush and filled in with living things to dynamically illustrate the change.

Affirmation messages (not shown) may be displayed with the impact field 700 reflective of the changes made (e.g. "Congratulations! That change resulted in 34% reduction in carbon emissions.")

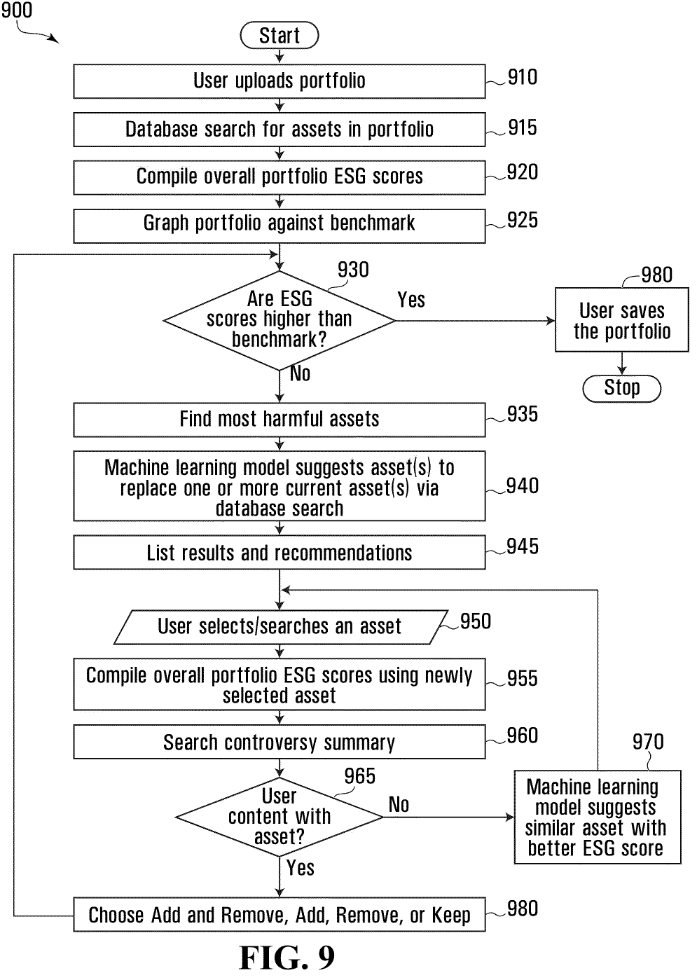

FIG. 9 is a flow diagram of overall process flow (alternative self-serve model). The process of FIG. 9 may be performed using the browser application 320, backend application 330, and database 340 depicted in FIG. 3. In the alternative self-service model, a portfolio is imported into the system at block 910 in a suitable format, such as in CSV format. The user (e.g., client) may, for example, upload their portfolio at block 910. The user then performs a database search for assets in the uploaded portfolio (block 915). The ESG composite score is determined for the portfolio as described above (block 920). This ESG composite score may further be graphed beside a benchmark (block 925), such as a known ESG composite score of a “good” or well-known fund or index, or against a comparable asset or portfolio (or against a prior actual or idealized iteration of the client’s own portfolio). The composite ESG score may be one score, or (as illustrated in FIGS. 4 and 6) may be a set or array of scores (“sub-scores”) (e.g. per pillar or per issue).

In order to make recommendations, it is first determined whether the ESG scores of the uploaded portfolio are higher than the benchmark (block 930). If not, the most “harmful” assets (i.e., the assets most responsible for a low ESG score) may be highlighted (block 935). A machine learning model (e.g., implemented via the machine learning server 370) may then perform a database search for assets with an ESG score better than the benchmark (block 940), and these may be listed as results and/or recommendations that may be added to the portfolio on a portfolio recommendations screen displayed, for example, on the browser application 320 (block 945). The user may select from this recommended list or may search for other assets in order to increase to overall ESG score and ideally score better than the benchmark (block 950). A new overall portfolio ESG score is then compiled that includes the newly selected asset (block 955). Optionally, the controversy summary for the newly selected asset, which is a report summarizing ESG-related incidents affecting the newly selected asset, may be searched for relevant information (block 960). This may be done by presenting the controversy summary to the user via the browser application 320 for the user to manually review, or by applying a machine learning model to perform natural language processing to process the controversy summary and highlight factors material to the overall ESG score. The user is then prompted as to whether they are content with including the newly selected asset in their portfolio (block 965). If not, for example if the user reads something in the controversy summary that is disqualifying or is unhappy with the newly selected asset’s effect on their portfolio’s overall ESG score, the machine learning model suggests similar assets in a manner analogous to block 940 but that would more positively contribute to the portfolio’s overall ESG score than the asset that the user is dissatisfied with (block 970). The process then returns to block 950 to allow the user to select another asset for inclusion in their portfolio.

If the user is content with the newly selected asset at block 965, they are prompted to confirm they wish to 1) add the newly selected asset to their portfolio and remove a different asset from their portfolio (i.e., replace that different asset with the newly selected asset); 2) just add the newly selected asset to their portfolio; 3) just remove one of their portfolio’s existing assets from the portfolio; or 4) make no changes to their portfolio (i.e., not add the newly selected asset to their portfolio, and not remove and existing assets from their portfolio) (block 980). Once done, the user returns to block 930. Although add/remove are shown as absolute options at block 980 in FIG. 9, it will be appreciated that this may also entail a reduction of an asset without removing it entirely, or increasing holding of an asset without adding all available holdings of that asset.

The machine learning model referenced above, such as in respect of block 940 in FIG. 9, may comprise an unsupervised machine learning model such as nearest neighbors or k-means clustering. The model may be used to return a recommendation in the form of a particular company in isolation, for example, or a particular fund representing multiple companies. For example, in respect of fund recommendations, in at least some embodiments a nearest neighbors model may be used in which n = 11 (i.e., for any given fund, ten nearest neighbors are found); a ball tree method is applied to determine distance; and distance is determined based on normalized values of an overall fund ESG quality score, an environmental pillar score, a social pillar score, and a governance pillar score. As another example and in respect of company recommendations, in at least some embodiments k-means clustering may be used in which k-means++ is used to find an initial value for k; four principal components are used; and distance is determined based on normalized values of a relative industry score, an absolute weighted average ESG score, an environmental pillar score, an environmental pillar weight, a social pillar score, a social pillar weight, a governance pillar score, a governance pillar weight, and an overall controversy score.

The decisions to increase/reduce holdings, add/drop assets, may be done on a simulation basis, or may be part of an actual buy/sell transaction(s). In some cases, the visualization tool may be directly connected to self-guided or advisor-assisted trading capabilities with respect to one or more accounts, so that separate systems are not needed and processing lag time is reduced.

Examples using equity assets have been provided throughout for simplicity. However, it is contemplated and within the scope of the present disclosure to provide handling for other asset types and classes as well. For example, to account for pooled funds, the portfolio may be split so the user can see how the funds are doing and how the companies are doing. This decoupling may be done to take into account that within funds there are more types of assets (ETFs, Mutual Funds, etc.). The existing ESG metrics/fields and features are the same for all those subcategories. Alternatively, funds and individual companies may be treated and displayed together.

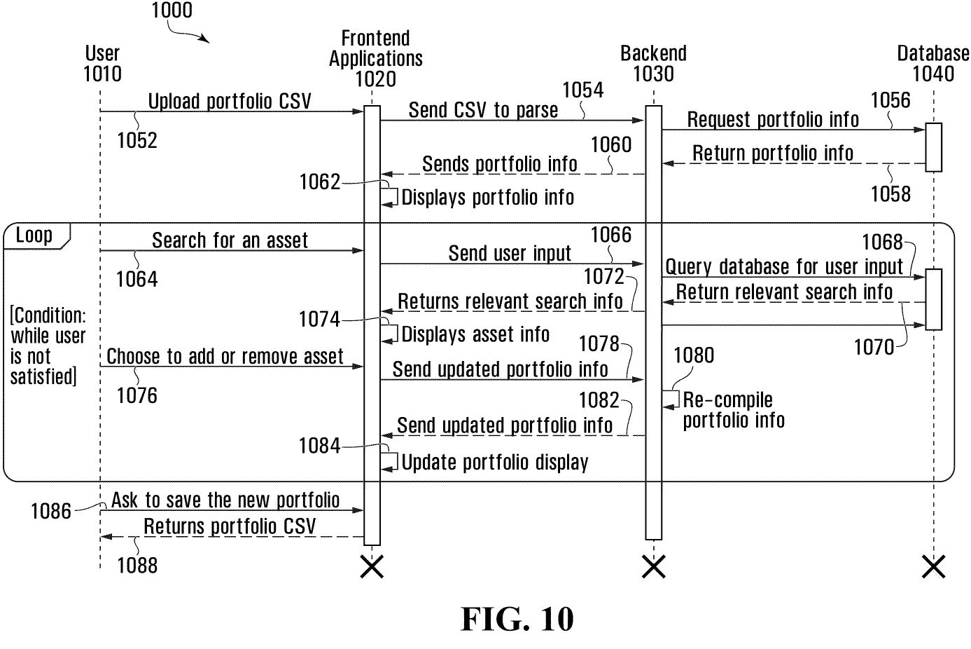

FIG. 10 is a sequence diagram 1000 generally based on FIG. 9 showing interactions between a user 1010, a front end application 1020, a backend 1030, and a database 1040. The front end application 1020, backend 1030, and database 1040 are analogous to the browser application 320, backend application 330, and database 340 of FIG. 3. Through the front end application 1020, the user 1010 uploads a portfolio in, for example, CSV format (interaction 1052, generally corresponding to block 910 of FIG. 9). The front end application 1020 sends the portfolio to the backend 1030 for parsing (interaction 1054), which requests portfolio-related information such as ESG scores from the database 1040 (interaction 1056, generally corresponding to block 915 of FIG. 9). The database returns that information to the backend 1030 (interaction 1058), which in turn sends it to the front end application 1020 (interaction 1060). The front end application 1020 compiles the portfolio’s ESG scores and displays them for the user 1010 (interaction 1062, generally corresponding to blocks 920 and 925 of FIG. 9).

Search functionality is provided (optionally showing comparable assets), and an iterative process may be permitted for add/remove of individual assets (or groups of assets), prior to saving. The backend 1030 in communication with database layer 1040 provides portfolio information and relevant search and updating. More particularly, the user 1010 searches for an asset via the front end application 1020, which relays the search query to the backend 1030, which in turn accordingly queries the database 1040 (interactions 1064, 1066, and 1068, generally corresponding to blocks 950, 970, and 965 of FIG. 9, except the database 1040 is searched as opposed to the machine learning model). The database 1040 returns search results to the backend 1030 (interaction 1070), which relays them to the front end application 1020 (interaction 1072). The front end application 1020 then displays information such as ESG score for the returned asset to the user 1010 (interaction 1074, with interactions 1070, 1072, and 1074 generally corresponding to block 960 of FIG. 9). The user 1010 then chooses to add or remove the returned asset (interaction 1076, generally corresponding to block 955 of FIG. 9). In response to that choice, the front end application 1020 sends updated portfolio information reflecting the addition or removal to the backend 1030 (interaction 1078), which re-compiles the portfolio information (interaction 1080). The backend 1030 sends the re-compiled portfolio information to the front end application (interaction 1082), which accordingly updates the portfolio display (interaction 1084, with interactions 1078, 1080, 1082, and 1084 generally corresponding to blocks 920 and 925 of FIG. 9). The user 1010 may perform the search functionality repeatedly until satisfied.

Once the user 1010 is completed searching and adjusting the portfolio, the user 1010 requests the front end application 1020 that the updated portfolio be saved (interaction 1086, generally corresponding to block 980 of FIG. 9), following which the front end application 1020 returns the portfolio to the user 1010 in CSV format (interaction 1088).

In the embodiments described above, user views may be the same as or different from the advisor and/or client views described above. In some embodiments, so-called “advisor” and “client” views may be combined in a single dashboard. In other embodiments, they may be deliberately separate and output to separate devices.

At least some of the embodiments described herein display key ESG data in a visualized and meaningful way to its users, providing them with ESG education components and uses other technologies to facilitate the implementation of ESG into investment portfolios. Users are preferably enabled to have a more convenient, efficient and streamlined process when making ESG investing choices and building portfolios.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of dynamically visualizing an impact field based on weighted environmental, social, and governance (ESG) metrics, comprising:
obtaining a portfolio including a plurality of assets according to a first configuration, each asset having an associated quantum variable;
retrieving for each of the assets a raw ESG score;
determining a weighted ESG score for each asset by multiplying the raw ESG score by the quantum variable;
forming a first composite ESG score by summing the weighted ESG scores for the assets in the first configuration of the portfolio;
visually representing the first configuration of the portfolio by rendering and displaying an impact field having a gradient variable reflective of the first composite ESG score;
making a recommendation for at least one asset in the first configuration;
receiving an instruction to reduce or increase the quantum variable of at least one asset, or to drop or add an asset, to form a second configuration of the portfolio;
retrieving for any new asset a raw ESG score;
determining a weighted ESG score for any new or modified asset by multiplying the raw ESG score by the quantum variable of the new or modified asset;
forming a second composite ESG score by summing the weighted ESG scores for the assets in the second configuration of the portfolio; and
visually representing the second configuration of the portfolio by modifying the appearance of the impact field through adjustment of the gradient so as to reflect the second composite ESG score.

2. The method of claim 1, wherein the quantum variable is expressed in shares, value, relative ranking within the portfolio by shares, or relative ranking within the portfolio by value.

3. The method of claim 1, wherein at least one of the retrieving steps includes retrieving ESG scores from multiple sources.

4. The method of claim 1, wherein the raw ESG scores include sets of sub-scores based on multiple issues.

5. The method of claim 4, further comprising receiving an issue preference from the user.

6. The method of claim 5, further comprising filtering the raw ESG scores to reflect only the sub-scores associated with the issue preference received from the user.

7. The method of claim 5, wherein the impact field applies a graphical template reflective of the issue preference.

8. The method of claim 1, wherein the gradient variable is selected from the group consisting of: intensity of a colour, position on a spectrum between two or more colours, number of a positive icon or graphic, number of a negative icon or graphic, and relative balance between positive icons or graphics and negative icons or graphics.

9. The method of claim 1, wherein the gradient variable is the visible health of an organism.

10. The method of claim 1, further comprising outputting the impact field to a different device than the recommendation.

11. The method of claim 1, further comprising outputting the scores to a different device than the impact field.

12. The method of claim 1, wherein the impact field is interactive and wherein interacting with the field generates messages pertaining to the assets, the portfolio, the ESG scores, or the recommendation.

13. The method of claim 1, further comprising storing a history of instructions and configurations and forming a persona of the holder based on the history of instructions and configurations.

14. The method of claim 13, further comprising outputting a message or a modification of the impact field based on the persona.

15. The method of claim 14, wherein the message is a recommendation based on past likes or patterns of instructions and configurations.

16. The method of claim 1, further comprising segmenting the portfolio by sector, region, currency, asset type or asset class.

17. The method of claim 1, wherein making the recommendation is performed by applying an unsupervised machine learning model.

18. The method of claim 17, wherein the recommendation is for a fund representing multiple companies.

19. A system for dynamically visualizing an impact field based on weighted environmental, social, and governance (ESG) metrics, comprising a terminal communicative with at least one server, the terminal and the at least one server collective configured to perform a method comprising:
obtaining a portfolio including a plurality of assets according to a first configuration, each asset having an associated quantum variable;
retrieving for each of the assets a raw ESG score;
determining a weighted ESG score for each asset by multiplying the raw ESG score by the quantum variable;
forming a first composite ESG score by summing the weighted ESG scores for the assets in the first configuration of the portfolio;
visually representing the first configuration of the portfolio by rendering and displaying an impact field having a gradient variable reflective of the first composite ESG score;
making a recommendation for at least one asset in the first configuration;
receiving an instruction to reduce or increase the quantum variable of at least one asset, or to drop or add an asset, to form a second configuration of the portfolio;
retrieving for any new asset a raw ESG score;
determining a weighted ESG score for any new or modified asset by multiplying the raw ESG score by the quantum variable of the new or modified asset;
forming a second composite ESG score by summing the weighted ESG scores for the assets in the second configuration of the portfolio; and
visually representing the second configuration of the portfolio by modifying the appearance of the impact field through adjustment of the gradient so as to reflect the second composite ESG score.

20. A non-transitory computer readable medium having stored thereon computer program code that is executable by a processor and that, when executed by the processor, causes the processor to perform a method of dynamically visualizing an impact field based on weighted environmental, social, and governance (ESG) metrics, comprising:
obtaining a portfolio including a plurality of assets according to a first configuration, each asset having an associated quantum variable;
retrieving for each of the assets a raw ESG score;
determining a weighted ESG score for each asset by multiplying the raw ESG score by the quantum variable;
forming a first composite ESG score by summing the weighted ESG scores for the assets in the first configuration of the portfolio;
visually representing the first configuration of the portfolio by rendering and displaying an impact field having a gradient variable reflective of the first composite ESG score;
making a recommendation for at least one asset in the first configuration;
receiving an instruction to reduce or increase the quantum variable of at least one asset, or to drop or add an asset, to form a second configuration of the portfolio;
retrieving for any new asset a raw ESG score;
determining a weighted ESG score for any new or modified asset by multiplying the raw ESG score by the quantum variable of the new or modified asset;
forming a second composite ESG score by summing the weighted ESG scores for the assets in the second configuration of the portfolio; and
visually representing the second configuration of the portfolio by modifying the appearance of the impact field through adjustment of the gradient so as to reflect the second composite ESG score.
